(19) United States
(12) Patent Application Publication
(10) Pub. No.: US 2005/0007350 A1
(43) Pub. Date: Jan. 13, 2005

(54) Wireless cursor-controlling device

(76) Inventor: Shoei-Lai Chen, Taipei (TW)

Correspondence Address: Yi-Wen Tseng, #D306, 509 ROOSEVELT BLVD., FALLS CHURCH, VA, 22044, US

(21) Appl. No.: 10/614,102

(22) Filed: Jul. 8, 2003

(51) Int. Cl. G09G 5/00

(52) U.S. Cl. 345/177

(57) ABSTRACT

A wireless cursor-controlling including a controller and a receiver is disclosed. The controller includes a main body and a cover. The main body includes a first containing space for placing at least one battery and a second containing space for placing the receiver. There is a holding portion formed in the second containing space. As such, it is convenient to combine the receiver in the controller for storing, carrying and using.

### BACKGROUND OF THE INVENTION

The present invention relates in general to a wireless cursor-controlling device and, more particularly, to a wireless cursor-controlling device including a controller and a receiver, wherein the receiver can be stored in the controller for conveniently carrying, storing and using.

Conventional projectors using transparent sheets in a briefing or a seminar are inconvenient. Instead, using computers are more popular. A speaker can utilize the software installed in the computer to provide a dynamic and dramatic performance. Meanwhile, a wireless computer cursor-controlling device is provided for the speaker to control the computer via infrared (IR) or radio frequency (RF) transmission.

A conventional wireless cursor-controlling device includes a controller and a receiver, as shown in FIG. 1. The receiver 20a has a connector 21a to plug in the computer. The controller 10a has a power switch 11a and a button 12a. While moving the controller 10a under the button 12a is pushed, a controlling signal is generated to transmit to be received by the computer via the receiver 20a; therefore, the computer cursor is moved accordingly.

However, the conventional wireless cursor-controlling device has the drawbacks as follows.

1. The controller 10a and the receiver 20a have to be used together, but they are separated and cannot be combined together; therefore, it may always happen to forget the receiver 20a when it is ready to use.

2. This kind of computer-related product is compact and sophisticated. That is, the receiver 20a is smaller for its portability; therefore, it may happen to lose without attention.

Therefore, there exist inconvenience and drawbacks for practically application of the above conventional connector structure. There is thus a substantial need to provide an improved connector structure that resolves the above drawbacks and can be used more conveniently and practically.

### BRIEF SUMMARY OF THE INVENTION

The present invention provides a wireless cursor-controlling device, which includes a controller having a containing space for receiving a receiver. It is convenient for storing, carrying and using.

The wireless cursor-controlling device provided by the present invention includes a controller and a receiver. The controller includes a main body and a cover. The main body includes a first containing space for placing at least one battery and a second containing space for placing the receiver.

### BRIEF DESCRIPTION OF THE DRAWINGS

These as well as other features of the present invention will become more apparent upon reference to the drawings wherein:

FIG. 1 shows a perspective view of a conventional wireless cursor-controlling device;

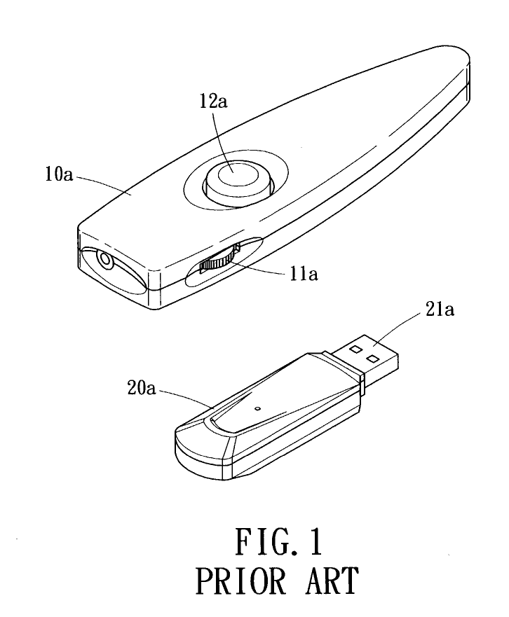

FIG. 2 shows an exploded view of the a wireless cursor-controlling device according to the present invention;

FIG. 3 shows a perspective view of the wireless cursor-controlling device according to the present invention;

FIG. 4 shows a partially combined wireless cursor-controlling device according to the present invention;

FIG. 5 shows an exploded view of a wireless cursor-controlling device according to another preferred embodiment of the present invention; and

FIG. 6 shows a combined wireless cursor-controlling device according to another preferred embodiment of the present invention.

### DETAILED DESCRIPTION OF THE INVENTION

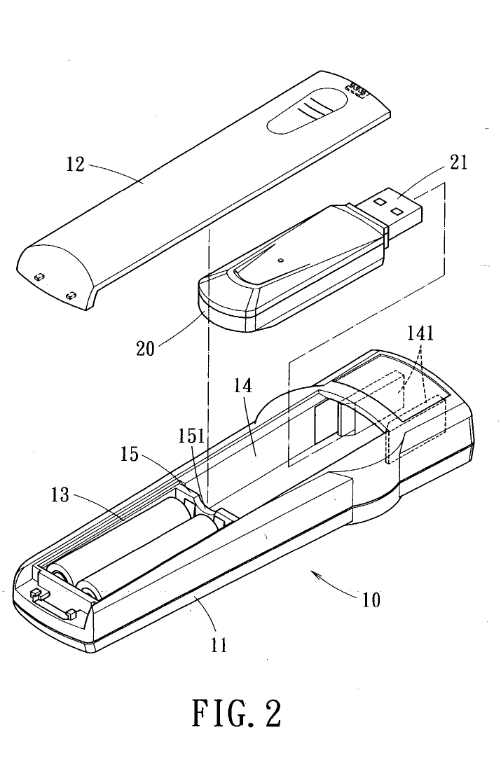

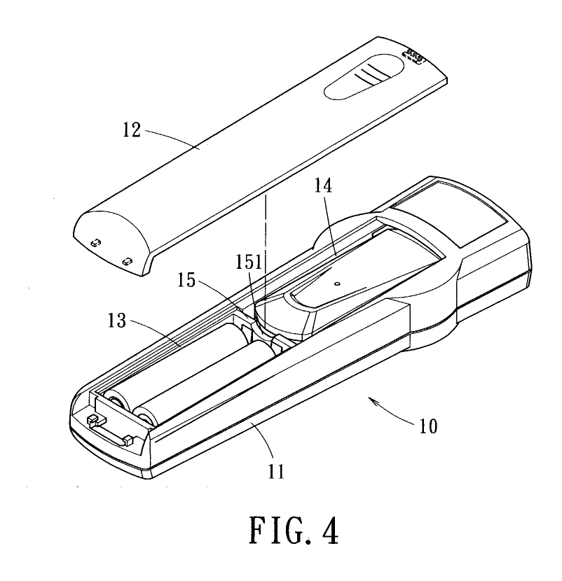

Please refer to FIGS. 2-4, the wireless computer cursor-controlling device of the present invention includes a controller 10 and a receiver 20.

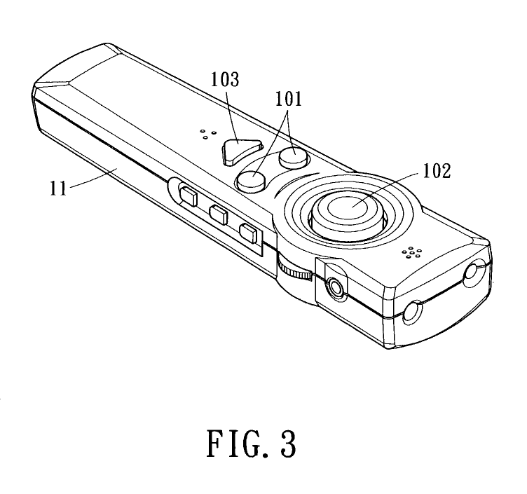

The controller 10 has a substantially rectangular shape with an easy handling portion. The front end of the controller 10 has an infrared transmitter. The controller 10 includes page-up and page-down buttons 101, a mouse button 102 and an enable button 103, as shown in FIG. 3. Thus, the speaker can hold the controller 10 to control the computer cursor under the operation of the buttons.

Furthermore, the controller 10 includes a main body 11 and a cover plate 12. There are a first containing space 13 and a second containing space 14 divided by an insulating plate 15 in the main body 11. The cover plate 12 is used to closely cover above the first and second containing space 13, 14. The separating plate 15 has a recess 151. The first containing space 13 is for placing the batteries 13.

The receiver 20 is for receiving the controlling signal transmitting from the controller 10, and can be put into the second containing space 14. There is a connecting portion 21 on one end of the receiver 20 to be connected to a corresponding port of the computer. In this preferred embodiment, the connecting portion 21 is a USB (universal serial bus) connector. A holding portion 141 is formed in the second containing space 14. The receiver 20 can be securely placed in the second containing space 14 by the holding portion 141. It is easy to take the receiver 20 out of the second containing space 14 for use.

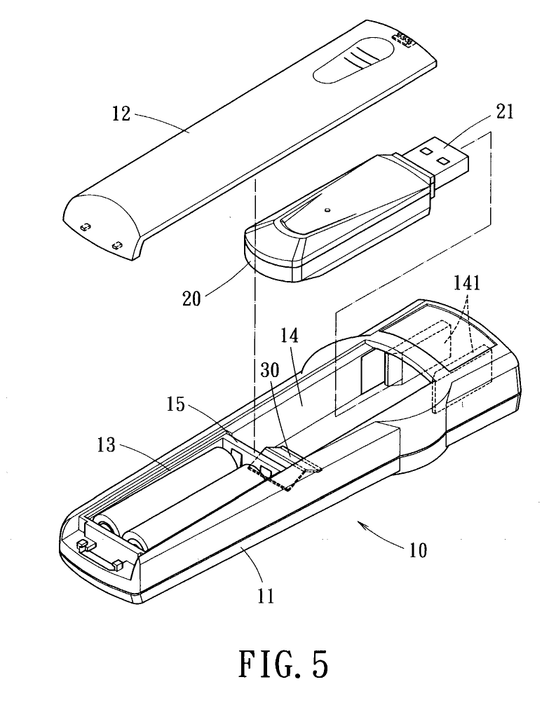

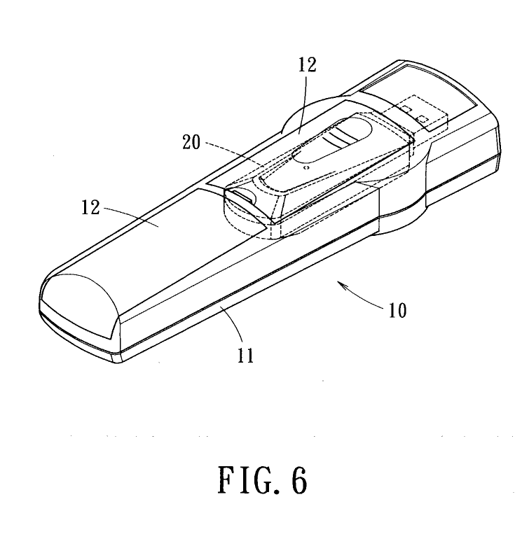

Referring to FIGS. 5 and 6, a resilient portion 30 is further formed in the second containing space 14 in another preferred embodiment.

The resilient portion 30 can be a leaf spring as in this preferred embodiment or a spiral spring and etc. By using the leaf, the receiver 20 is placed on the resilient portion 30; therefore, while the cover 12 is removed from the main body 11, the receiver 20 will be raised by the resilient portion 30. As such, it is much easier to take out the receiver 20.

According to the wireless cursor-controlling device of the present invention, it provides at least the advantages as follows.
1. The controller has a space for receiving the receiver; therefore, it is convenient in storing, carrying and using.
2. The receiver is securely placed in the controller; therefore, it prevents the receiver from missing.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

1. A wireless cursor-controlling device comprising:,
a controller including a main body and a cover, the main body including a first containing space for placing at least one battery and a second containing space; and
a receiver including a connecting portion, capable of placing in the second containing space.

2. The wireless cursor-controlling device of claim 1, wherein the main body includes a holding portion formed in the second containing space, capable of securely holding the connecting portion of the receiver.

3. The wireless cursor-controlling device of claim 1, wherein the main body includes a separating plate formed between the first and the second containing spaces.

4. The wireless cursor-controlling device of claim 1, wherein the main body includes a resilient portion formed in the second containing space.

5. The wireless cursor-controlling device of claim 4, wherein the resilient portion is a leaf spring.

6. The wireless cursor-controlling device of claim 4, wherein the resilient portion is a spiral spring.
